(19) United States
(12) Patent Application Publication
(10) Pub. No.: US 2026/0222683 A1
(43) Pub. Date: Jul. 30, 2026

(54) IMAGING APPARATUS AND IMAGE PROCESSING METHOD

(71) Applicant: Panasonic Intellectual Property Management Co., Ltd., Osaka (JP)

(72) Inventors: Masatoshi NAKAMURA, Kyoto (JP); Shinichi YAMAMOTO, Osaka (JP)

(73) Assignee: Panasonic Intellectual Property Management Co., Ltd., Osaka (JP)

(21) Appl. No.: 19/445,794

(22) Filed: Jan. 12, 2026

(30) Foreign Application Priority Data
Jan. 28, 2025 (JP) 2025-012190

(51) Int. Cl. H04N 23/67; H04N 23/60; H04N 23/63; H04N 23/61

(52) U.S. Cl. CPC H04N 23/675; H04N 23/631; H04N 23/64; H04N 23/61

(57) ABSTRACT

An imaging apparatus includes: an image sensor configured to capture an image of a subject via an optical system to generate image data indicating a captured image; a controller configured to control image processing to generate an edited image based on the image data; and an input interface configured to input user instruction on bokeh in the edited image. The controller is configured to: generate an all-in-focus image for each frame based on the image data sequentially generated by the image sensor, the all-in-focus image being in focus over a wider range than the captured image; and generate video data including the edited image with the image processing applying a bokeh amount to the all-in-focus image in accordance with the user instruction input via the input interface.

### TECHNICAL FIELD

The present disclosure relates to an imaging apparatus and image processing method for including bokeh in an edited image.

### BACKGROUND ART

JP 2008-294785 A discloses an image processing device that applies blurring processing to captured images containing multiple subjects. JP 2008-294785 A focuses on the problem that, in compact imaging apparatuses such as small digital cameras, the depth of field of captured images is deep, resulting in focus being applied uniformly from near to far, making it difficult to capture images with a bokeh effect. Accordingly, the image processing device of JP 2008-294785 A, when capturing an image, divides the image into multiple regions and obtains distance information to subjects contained within each region. Based on this distance information, it sets a blurring degree for each region and applies blurring processing to each region according to that degree. This enables the creation of an image with a bokeh effect, where regions within the image exhibiting a lower degree of blurring appear to stand out.

### SUMMARY

The present disclosure provides an imaging apparatus and image processing method that can facilitate having bokeh effect in line with the user's intent in video.

In an aspect of the present disclosure, an imaging apparatus includes: an image sensor configured to capture an image of a subject via an optical system to generate image data indicating a captured image; a controller configured to control image processing to generate an edited image based on the image data; and an input interface configured to input user instruction on bokeh in the edited image. The controller is configured to: generate an all-in-focus image for each frame based on the image data sequentially generated by the image sensor, the all-in-focus image being in focus over a wider range than the captured image; and generate video data including the edited image with the image processing applying a bokeh amount to the all-in-focus image in accordance with the user instruction input via the input interface.

In an aspect of the present disclosure, an imaging processing method is a method for controlling image processing to generate an edited image based on image data obtained by capturing an image of a subject via an optical system. The method includes: obtaining, by a controller, an all-in-focus image frame by frame, the all-in-focus image being in focus over a wider range than a captured image indicated by the image data; and generating, by the controller, video data including the edited image with the image processing applying a bokeh amount to the all-in-focus image in accordance with an input user instruction.

In another aspect of the present disclosure, an imaging apparatus includes: an image sensor configured to capture an image of a subject via an optical system to generate image data indicating a captured image; a controller configured to control image processing to generate an edited image based on the image data; and an input interface configured to input user instruction on bokeh in the edited image. The user instruction includes scenario information indicating a scenario planned for a video. The controller is configured to generate video data including the edited image with the image processing applying a bokeh amount to each frame of the video, according to the scenario information.

According to the imaging apparatus of the present disclosure, the imaging apparatus and image processing method disclosed herein, it is possible to facilitate having the bokeh effect in the video in line with the user's intent.

### BRIEF DESCRIPTION OF THE DRAWINGS

FIG. 1 is an exemplary diagram illustrating a configuration of an imaging system in a first embodiment of the present disclosure;

FIG. 2 is a diagram showing a configuration of a digital camera in the imaging system;

FIGS. 3A to 3D are diagrams illustrating an operation of the imaging system;

FIG. 4 is a flowchart illustrating a video shooting operation of the digital camera in the imaging system of the first embodiment;

FIG. 5 is a flowchart illustrating a video editing operation in the imaging system of the first embodiment;

FIG. 6 is a diagram illustrating an example of the video editing operation in the imaging system of the first embodiment;

FIG. 7 is a flowchart illustrating bokeh editing process in the imaging system;

FIGS. 8A to 8C shows display examples of the bokeh editing process in the imaging system;

FIG. 9 is a flowchart illustrating bokeh image processing in the imaging system of the first embodiment;

FIG. 10 is a graph showing an example of a bokeh determination function in the imaging system;

FIG. 11 is a diagram illustrating a bokeh map in the imaging system;

FIG. 12 is a diagram illustrating a variation of the bokeh map in the imaging system;

FIG. 13 is a flowchart illustrating bokeh reflection process in the imaging system;

FIG. 14 shows a display example in the bokeh reflection process in the imaging system;

FIG. 15 is a flowchart illustrating video editing operation in the imaging system of a second embodiment;

FIG. 16 is a flowchart illustrating automatic editing process in the imaging system of the second embodiment;

FIG. 17 is a flowchart illustrating bokeh image processing in the second embodiment; and

FIG. 18 is a flowchart illustrating an operation of the imaging system in a modified example.

### DETAILED DESCRIPTION

Hereinafter, embodiments will be described in detail with reference to the drawings as appropriate. However, detailed description of an already well-known matter and overlapping description for substantially the same configuration may be omitted. Note that the accompanying drawings and description below are provided to enable those skilled in the art to sufficiently understand the present disclosure, and these are not intended to limit the subject matter described in the claims.

### First Embodiment

### 1. Configuration

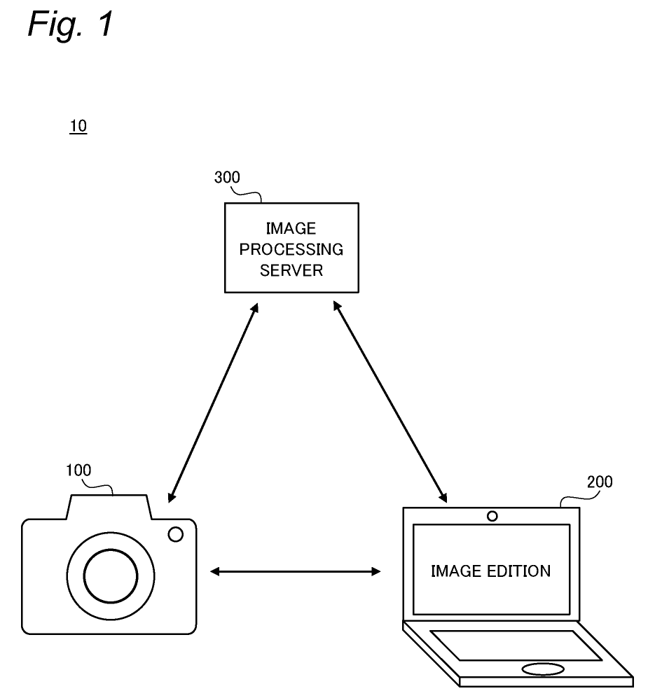

An imaging system of a first embodiment of the present disclosure is described with reference to FIG. 1.

As shown in FIG. 1, the present system 10 includes a digital camera 100, an image editing terminal 200, and an image processing server 300. In the present system 10, the digital camera 100 and the image editing terminal 200 are connected for data communication via wired or wireless communication, for example. The image processing server 300 is connected for communication with the digital camera 100 and the image editing terminal 200 via a communication network such as the Internet. The present system 10 may be a network-based system.

The present system 10 is applicable for a user to shoot and edit video or still images using the digital camera 100, for example. For example, the present system 10 can be applied to image editing, such as reproducing the user's desired bokeh effect in post-processing after the shooting.

The image editing terminal 200 is an information processing device, such as a personal computer (PC), tablet device, or smartphone. The user of the present system 10 may edit image data shot by the digital camera 100 on the image editing terminal 200, or may perform image editing directly on the digital camera 100.

For example, the image editing terminal 200 includes a processor such as a CPU or MPU, memory such as ROM or RAM, and various input/output interfaces. In the present system 10, the image editing terminal 200 need not be in communication with either or both of the digital camera 100 and the image processing server 300. For example, data from the digital camera 100 may be input to the image editing terminal 200 via a portable recording medium such as a memory card.

The image processing server 300 is a server device composed of various computers, such as a cloud server. For example, the image processing server 300 can appropriately perform various information processing tasks, such as image processing, for the present system 10. For example, the image processing server 300 includes processors such as a CPU and GPU, memory such as ROM and RAM, and various input/output interfaces. System 10 may not necessarily include image processing server 300.

### 1.1. Digital Camera Configuration

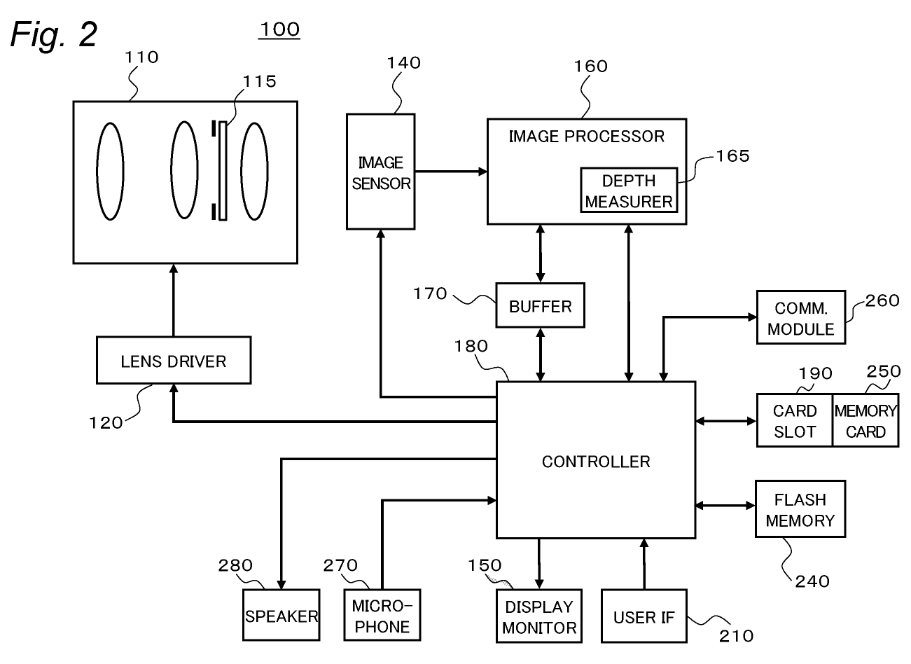

A configuration of the digital camera 100 in this embodiment is explained with reference to FIG. 2.

FIG. 2 is a diagram showing the configuration of the digital camera 100 according to this embodiment. The digital camera 100 of this embodiment includes an optical system 110, a lens driver 120, and an image sensor 140. Furthermore, the digital camera 100 includes an image processor 160, a buffer memory 170, a controller 180, a user interface 210, and a display monitor 150. Additionally, the digital camera 100 includes a flash memory 240, a card slot 190, a communication module 260, a microphone 270, and a speaker 280.

The optical system 110 includes a zoom lens and a focus lens, among others. The zoom lens is a lens for changing the magnification of the subject image formed by the optical system. The focus lens is a lens for changing the focus state of the subject image formed on the image sensor 140. The zoom lens and the focus lens are composed of one or more lenses.

In the digital camera 100 of this embodiment, the optical system 110 further includes a phase plate 115 that imparts a predetermined phase difference to the wavefront of incident light. For example, the phase plate 115 is substantially planar and composed of a transmissive material that transmits visible light. For example, the phase difference of the phase plate 115 is set by a wavefront encoding method to impart bokeh for encoding, which is to be subsequently removed from the image in post-processing, onto the subject image formed by the optical system 110 and, consequently, onto the captured image of the image sensor 140.

The information indicating the bokeh for encoding by the phase plate 115 (e.g., PSF) is pre-stored in the flash memory 240 of the digital camera 100, for example. The phase plate 115 has a thickness that is rotationally asymmetric with respect to the optical axis, for example. The thickness of the phase plate 115 is set appropriately from the perspective of significantly ensuring a depth of field where the bokeh for encoding is of a similar degree. For example, the phase plate 115 is positioned at the pupil position, such as the aperture position, in a direction perpendicular to the optical axis of the optical system 110. The phase plate 115 is an example of an optical element that provides encoding-specific bokeh corresponding to the aforementioned phase difference.

The lens driver 120 includes a configuration for driving each of the various lenses in the optical system 110, such as the focus lens. For example, the lens driver 120 includes a motor and moves the focus lens along the optical axis of the optical system 110 based on control from the controller 180. The configuration for driving the focus lens within the lens driver 120 can be implemented using a DC motor, a stepping motor, a servo motor, or an ultrasonic motor.

The image sensor 140 captures the subject image incident through the optical system 110 and generates image data. The image data generated by the image sensor 140 is input to the image processor 160.

The image sensor 140 generates image data for new frames at a predetermined frame rate (e.g., 30 frames per second). The timing of image data generation and electronic shutter operation within image sensor 140 are controlled by controller 180. The image sensor 140 may be various image sensors, such as a CMOS image sensor, a CCD image sensor, or an NMOS image sensor.

The image sensor 140 performs an imaging operation for a moving image and still image, as well as an imaging operation for a through image. The through image is primarily a moving image and is displayed on the display monitor 150 to allow the user to determine the composition. The image sensor 140 is an example of an image sensor in this embodiment.

The digital camera 100 of this embodiment may include an on-chip phase detection autofocus system. For example, the image sensor 140 may include sensor pixels that constitute the autofocus points of the on-chip phase detection system. For example, the sensor pixels may include photoelectric conversion elements that are divided to form two or more optical images split by the optical system 110. Such sensor pixels may be provided as light-blocking pixels separate from the pixels for RGB images on the image sensor 140, or may be shared with the pixels for RGB images.

The image processor 160 performs predetermined processing on the image signal output from the image sensor 140 to generate image data, or applies various processing to the image data to generate an image for display on the display monitor 150. Examples of the predetermined processing include white balance correction, gamma correction, YC conversion processing, electronic zoom processing, compression processing, and decompression processing, but are not limited to these. The image processor 160 may be configured using hardwired electronic circuits or using a microcomputer, processor, or similar device employing software.

In this embodiment, the image processor 160 includes a depth measurer 165 that implements an on-chip phase-difference ranging function, for example. The depth measurer 165 performs on-chip phase-difference ranging based on sensor signals input from sensor pixels in the image sensor 140, generating a depth map that indicates the depth from the digital camera 100 to subjects in the captured image on a per-pixel basis. , For example, phase-detection autofocus on the image plane can be performed by calculating, for each measurement point by the sensor pixels, the amount of defocus corresponding to the difference between two optical images obtained by pupil splitting from the sensor signal.

The depth measurer 165 is not specifically limited to an on-chip phase detection method. In this case, the image sensor 140 of the digital camera 100 need not specifically include sensor pixels for an on-chip phase detection method. For example, various ranging methods may be applied to the depth measurer 165, such as depth estimation using AI (artificial intelligence) like machine learning, the Time Of Flight (TOF) method, dual-camera stereo ranging, color-based ranging, or a rangefinder.

The buffer memory 170 is a recording medium that functions as a working memory for the image processor 160 and the controller 180. The buffer memory 170 is implemented using a DRAM (Dynamic Random Access Memory) or similar device. The flash memory 240 is a non-volatile recording medium. Each memory 170 and 240 is an example of a memory in this embodiment.

The controller 180 controls the overall operation of the digital camera 100. For control operations and image processing operations, the controller 180 uses the buffer memory 170 as a work memory.

The controller 180 includes a CPU or MPU to execute a program (software) to perform predetermined functions. The controller 180 may include a processor composed of dedicated electronic circuits designed to perform predetermined functions instead of a CPU or the like. That is, the controller 180 can be implemented using various circuitry such as a CPU, MPU, GPU, DSU, FPGA, or ASIC. The controller 180 may include one or more processors.

The card slot 190 is an example of an input interface capable of accommodating the memory card 250 and accessing the memory card 250 based on control from the controller 180. The digital camera 100 can record image data onto the memory card 250 and read the recorded image data from the memory card 250.

The user interface 210 is a general term for various user interfaces, such as operation members, that receive user operations (instructions), and is an example of an input interface. The user interface 210 includes buttons, levers, dials, touch panels, switches, etc., that receive user operations, such as a video shooting button and function buttons. Furthermore, the user interface 210 may also include virtual buttons and icons displayed on the display monitor 150 or the like.

The display monitor 150 is an example of a display (and thus an example of an output interface) that displays various information. For example, the display monitor 150 displays an image (through image) shown by image data captured by the image sensor 140 and processed by the image processor 160. Furthermore, the display monitor 150 displays menu screens and the like for the user to configure various settings for the digital camera 100. The display monitor 150 can be configured as an LCD display device or an OLED device, for example.

The communication module 260 is a module (circuit) that performs communication compliant with standards such as IEEE 802.11 or Wi-Fi, Bluetooth or the like. The digital camera 100 may communicate directly with other devices via the communication module 260, or may communicate via an access point. The communication module 260 may be capable of connecting to communication networks such as the Internet. The communication module 260 is an example of an input interface for establishing communication connections with various external devices.

The microphone 270 includes one or more microphone elements built into digital camera 100, for example. The microphone 270 is an example of an input interface that captures audio from outside digital camera 100. The microphone 270 outputs an audio signal indicating the captured audio to the controller 180. An external microphone may also be used with the digital camera 100. The digital camera 100 may include a connection port, such as a terminal for connecting to an external microphone, as an input interface, alternatively or additionally to the built-in microphone 270.

The speaker 280 includes one or more speaker elements built into digital camera 100, for example. The speaker 280 outputs audio outside digital camera 100 under control from controller 180. The digital camera 100 may also use an external speaker, earphones or the like. The digital camera 100 may include a connection port for connecting to an external speaker or the like, alternatively or additionally to the built-in speaker 280.

### 2. Operation

The operation of the imaging system 10 and the digital camera 100, configured as described above, is explained below.

### 2.1. Overview of Operation

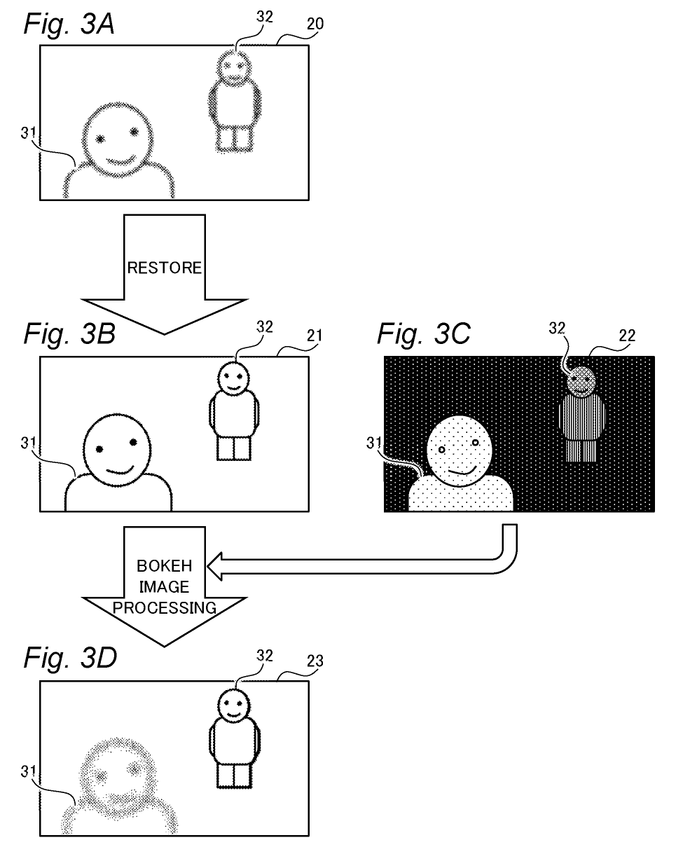

The operation of the imaging system 10 of this embodiment is described using FIG. 3.

FIG. 3A illustrates an image 20 captured by the digital camera 100 of the present system 10. FIG. 3B shows an all-in-focus image 21 based on the captured image 20 of FIG. 3A in the present system 10.

In the present system 10, as shown for example in FIG. 3A, the captured image 20 from the digital camera 100 is given a bokeh effect encoded by the phase plate 115. Consequently, in the captured image 20 illustrated in FIG. 3A, for example, both the relatively near subject 31 and the distant subject 32 exhibit a similar bokeh effect.

The present system 10 performs image processing to restore the all-in-focus image 21, as shown for example in FIG. 3B, based on the information indicating such bokeh for encoding and the captured image 20. This restored image has all subjects 31, 32 in focus, which are blurred in the captured image 20. The all-in-focus image 21 has a wider range of focus than the original captured image 20, such as being in focus throughout the entire image. According to the present system 10, encoding and decoding in the digital camera 100, for example, facilitates the generation of such an all-in-focus image 21 with a significantly restored depth of field.

FIG. 3C illustrates a depth map 22 corresponding to the all-in-focus image 21 shown in FIG. 3B. The present system 10 generates the depth map 22 during the image shooting by the digital camera 100, for example. This depth map 22 shows, on a per-pixel basis, the depth that is a distance from various subjects 31, 32 in the captured image 20 to the digital camera 100, alongside the captured image 20 shown in FIG. 3A.

FIG. 3D illustrates an edited image 23 based on the all-in-focus image 21 from FIG. 3B and the depth map 22 from FIG. 3C. The example in FIG. 3D shows a case where one subject 31, among multiple subjects 31, 32, is the user's desired focus target.

The present system 10 generates the edited image 23, as exemplified in FIG. 3D, based on the all-in-focus image 21 (FIG. 3B) and the depth map 22 (FIG. 3C), to focus on the desired subject 32 and reproduce natural bokeh. The edited image 23 is generated by applying image processing to the all-in-focus image 21 for editing purposes, such as creating the natural bokeh where subjects at different depths from the focused subject 32 appear blurred.

The present system 10 can provide the user with flexible bokeh expression through natural bokeh effects in the edited image 23 or further bokeh editing. In this embodiment, an example operation is described below where, for instance, image processing illustrated in FIGS. 3A to 3D is performed in the digital camera 100 to generate video data including the edited images 23 according to user editing operations.

### 2.2. Video Shooting Operation

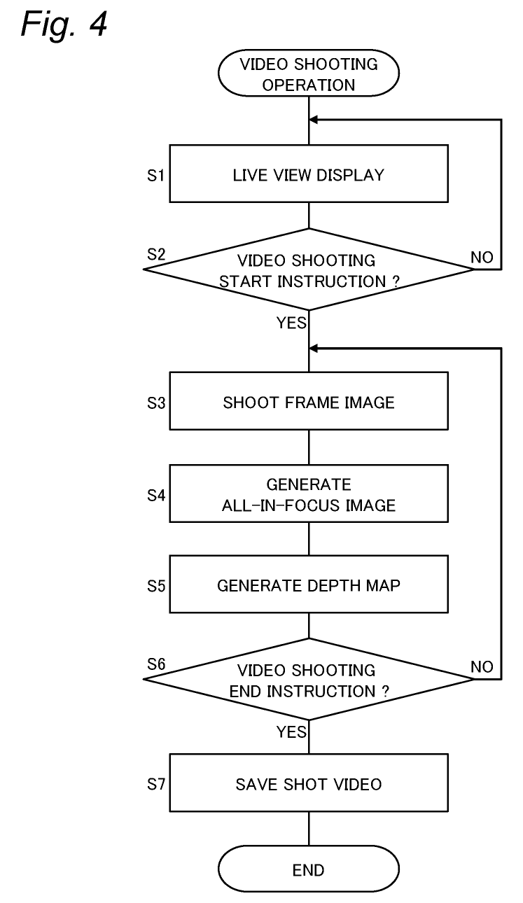

The operation of shooting video using the digital camera 100 in the present system 10 is explained using FIG. 4.

FIG. 4 is a flowchart illustrating the video shooting operation of the digital camera in the present system 10. The processing shown in FIG. 4 is executed by the controller 180 of the digital camera 100, for example.

First, the controller 180 of the digital camera 100 displays a live view screen showing a real-time captured image 20 on the display monitor 150, based on the captured data generated frame by frame by the image sensor 140, for example during standby for video shooting (S1). In the present system 10, the bokeh amount encoded by the phase plate 115, for example, is appropriately set to a small level acceptable from the user's visibility perspective, even when the captured image 20 is used in such a live view screen.

With the display of the live view screen (S1), the controller 180 receives a video shooting start instruction, such as a user operation of the video shooting button on the user interface 210 (S2). For example, when no video shooting start instruction is input (NO at S2), the controller 180 repeats the processing of step S1 at a predetermined frame period.

On the other hand, when the video shooting start instruction is input (YES in S2), the controller 180 starts various controls for video shooting. For example, the controller 180 controls the imaging operation of the image sensor 140 frame by frame to generate imaging data for recording purposes, separate from that for the live view (S3). According to the imaging operation in step S3, the encoded captured image 20 is generated for each frame, as shown in FIG. 3A, for example.

Next, the controller 180 causes the image processor 160 to perform restoration image processing on the imaging data of the captured image 20 for each frame or the like, thereby generating image data for the all-in-focus image 21, as illustrated in FIG. 3B (S4). The restoration image processing in step S4 is implemented by an operation that performs the inverse convolution of the point spread function (PSF) that represents the bokeh imparted by the phase plate 115.

For example in step S4, the controller 180 causes the image processor 160 to perform the image restoration processing using a method that accounts for noise, such as a Wiener filter, by referring to pre-set information such as the PSF of the phase plate 115 (S4). For example, in an ideal case where noise is negligible, the all-in-focus image 21 can be restored by dividing each pixel (i.e., each spatial frequency component) of the transformed image, which is obtained by the Fourier transform of the captured image 20, by the optical transfer function (OTF), which is obtained by Fourier transforming of the PSF of the phase plate 115, and then performing an inverse Fourier transformation thereon.

For example, the controller 180 operates the depth measurer 165 based on the imaging data from step S3, to generate the depth map 22 as illustrated in FIG. 3C (S5). Note that the processing order of steps S4 and S5 is not necessarily limited to the order shown in the figure; they may be performed in reverse order or simultaneously.

The controller 180 receives a video shooting end instruction, such as user operation of the video shooting button on the user interface 210, during the execution of such video shooting (S6). When no video shooting end instruction is input (NO at S6), the controller 180 repeats the processing from step S3 onwards at a predetermined frame period, for example.

On the other hand, when the video shooting end instruction is input (YES in S6), the controller 180 performs various controls to end video shooting. For example, the controller 180 saves the recorded video by writing the video data obtained as a result of recording in steps S3 to S6 to the memory card 250 via the card slot 190 (S7).

For example, the video data (S7) of the shooting result from the digital camera 100 of this embodiment includes all-in-focus images 21 for each frame, and is recorded with depth maps 22 associated with the all-in-focus images 21. For example, the controller 180 may manage the video of the all-in-focus images 21 and the video of the depth maps 22 in synchronization, or may manage the depth maps 22 as metadata for the video data of the all-in-focus images 21.

The controller 180 terminates the processing shown in the flowchart of FIG. 4, for example, after saving the captured video (S7). Recording the video data for saving the captured video may be performed not only in step S7, but also for one or more frames in steps S3 to S6. Furthermore, saving the video data (S7) is not limited to recording onto the memory card 250; it may also be recorded on the image editing PC 200 or image processing server 300 by transmitting data from the digital camera 100 via the communication module 260, for example.

According to the above processing, the digital camera 100 of the present system 10 can generate the all-in-focus image 21 for each frame (S3) using the captured image 20 (S3) encoded by the phase plate 115, and generate the video data including the all-in-focus image 21 (S7). In the video shooting, the digital camera 100 of this embodiment can generate the depth map 22 corresponding to the all-in-focus image 21 (S5) along with the frame-by-frame all-in-focus image 21 (S4), to generate the video data of the shooting result including the all-in-focus image 21 and the depth map 22 (S7).

The live view display in step S1 may use not only the encoded captured image 20 but also the restored all-in-focus image 21, for example. In this case, the controller 180 generates the all-in-focus image 21 in the same manner as step S4, even before the video shooting start instruction (NO in S2). Furthermore, the digital camera 100 may perform the live view display in the video shooting in steps S3 to S6, similar to step S1.

Generation of the all-in-focus image 21 (S4) may be performed not only within the video shooting operation but also post-recording, and may be performed outside the digital camera 100. For example, the image editing PC 200 or the image processing server 300 of the present system 10 can obtain the video data of the captured images 20 from the digital camera 100 and the PSF information of the phase plate 115, and generate the all-in-focus image 21 for each frame of the video data using image processing similar to step S4.

### 2.3. Video Editing Operation

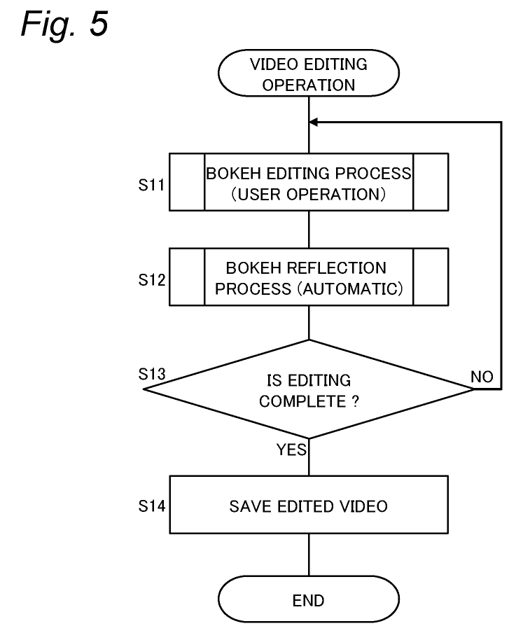

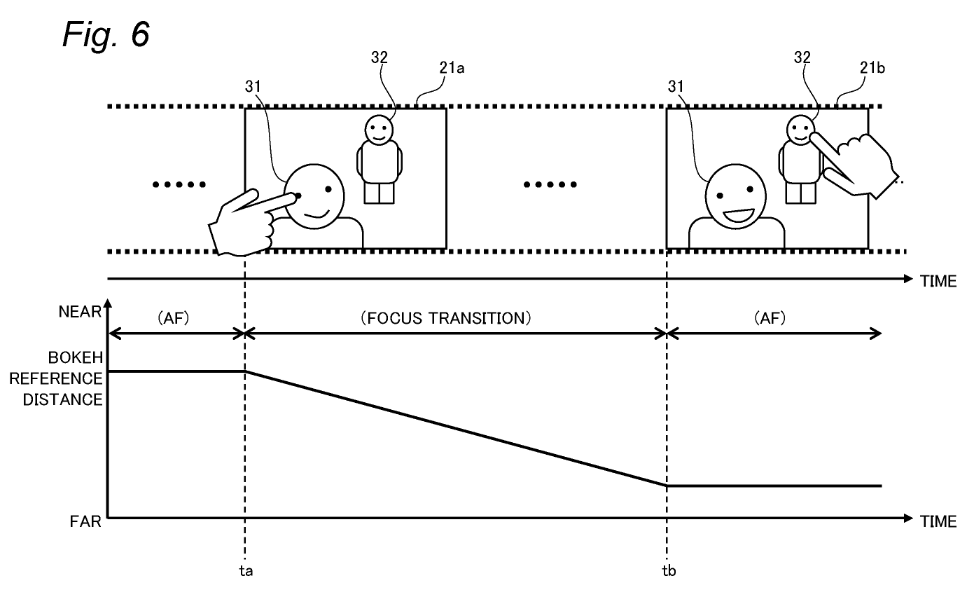

In the present system 10, the operation of applying bokeh editing to video footage shot by the digital camera 100, as described above, is explained using FIGS. 5 to 6.

FIG. 5 is a flowchart illustrating the video editing operation in the present system 10. The processing shown in FIG. 5 is executed by the controller 180 of the digital camera 100, for example.

First, in the present system 10, the controller 180 performs image processing on frame images in the video data shot by the digital camera 100 to express the user-desired bokeh effect, in accordance with user editing operations performed at the user interface 210, for example (S11). In the bokeh editing process (S11) of this embodiment, image processing is performed based on the all-in-focus image 21 as a frame image of the video and the corresponding depth map 22, to freely apply the bokeh effect desired by the user. Details of the bokeh editing process (S11) will be described later.

Next, the controller 180 performs image processing (S12) to automatically apply the bokeh effect to each subsequent frame following the frame image processed in step S11, in accordance with the user's instructions in the bokeh editing process, for example (S11). In the bokeh reflection process (S12) of this embodiment, for example, to reproduce the AF operation of the digital camera 100, a bokeh effect is automatically applied to the images of various frames, generating the video data with the bokeh editing applied. Details of the bokeh reflection process (S12) will be described later.

The bokeh reflection process (S12) is performed for the user-desired time interval in the video indicated by the shot video data (see FIG. 6). For example, after executing step S12, responding to user operation at the user interface 210, the controller 180 determines whether the video editing is complete (S13).

For example, when the user inputs an operation to edit the bokeh for a new frame image, the controller 180 proceeds to NO in step S13 and repeats the processing from step S11 onwards in response to the new user edit operation.

On the other hand, when the user inputs the video editing completion operation to the user interface 210, the controller 180 proceeds to YES in step S13 and saves the edited video data (S14). For example, the controller 180 stores the video data including the edited frame images, as the result of processing steps S11 to S12, onto the memory card 250 via the card slot 190.

After saving the edited video (S14), the controller 180 terminates the processing shown in the flowchart of FIG. 5, for example. For saving the edited video, the recording of the video data is not limited to step S14; it may also be performed at an appropriate time during steps S11 to S13. Furthermore, saving the video data (S14) is not limited to recording onto the memory card 250; it may also be recorded on the image editing PC 200 or the image processing server 300 by transmitting data from the digital camera 100 via the communication module 260, for example.

Based on the above processing, the present system 10 can perform bokeh image processing on the all-in-focus image 21 according to the user editing operation (S11), and further perform image processing (S12) to reflect the user-desired bokeh in the video, thereby generating an edited video with freely expressible bokeh effects. An example of this video editing operation of the present system 10 is explained using FIG. 6.

FIG. 6 is a diagram illustrating an example of focus transition video editing operation in the present system 10. FIG. 6 shows the time sequence of frame images 21a to 21b in the video data and a timing chart indicating the change in the bokeh reference distance corresponding to this time sequence. The bokeh reference distance is the distance used as the reference for applying the bokeh effect and corresponds to the focus distance.

In the example of FIG. 6, the user editing operation in step S11 includes an instruction to edit the frame image 21a at time ta such that the relatively near subject 31 is in focus while the distant subject 32 is blurred, for example via touch operation. Furthermore, the user instruction for the frame after time ta includes a setting where the focus target in frame image 21b at time tb shifts to the distant subject 32.

For example, reflecting such user instructions, the controller 180 performs the image processing (S12) as shown in FIG. 6, continuously changing the bokeh reference distance between time ta and time tb to apply the bokeh effect for the corresponding in-focus state in each frame. For example, the bokeh effects are applied to the frame images between time ta and time tb to reproduce the focus distance between the distance to one subject 31 and the distance to the other subject 32.

As described above, according to the present system 10, the user can edit video to express focus transitions, such as gradually shifting the focus state between desired subjects 31 and 32. Furthermore, in the example of FIG. 6, the reproduction method for AF operation distinct from the focus transition during the period ta to tb is set for the period before time ta and the period after time tb. According to the present system 10, by performing the processing of steps S11 to S13 for each desired time interval in the video, it is possible to generate the edited video where bokeh is automatically reflected in various AF operation reproduction methods, for example.

Furthermore, in the present system 10, some or all of the various processes involved in the video editing operation illustrated in FIG. 5 may be performed not only by the controller 180 of the digital camera 100, but also, for example, by the image editing PC 200 or the image processing server 300. Additionally, the video editing operation may be executed through the cooperation between the various components 100, 200, and 300 of the present system 10.

### 2.3.1. Bokeh Editing Process

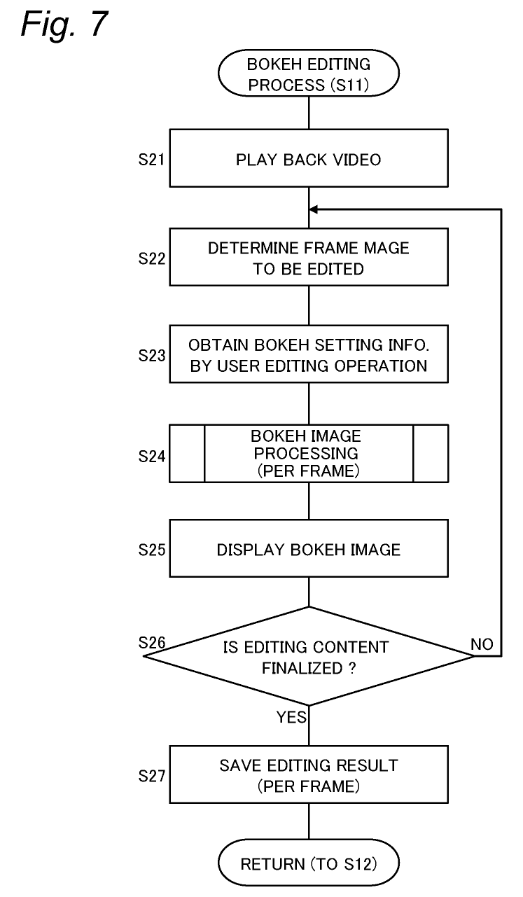

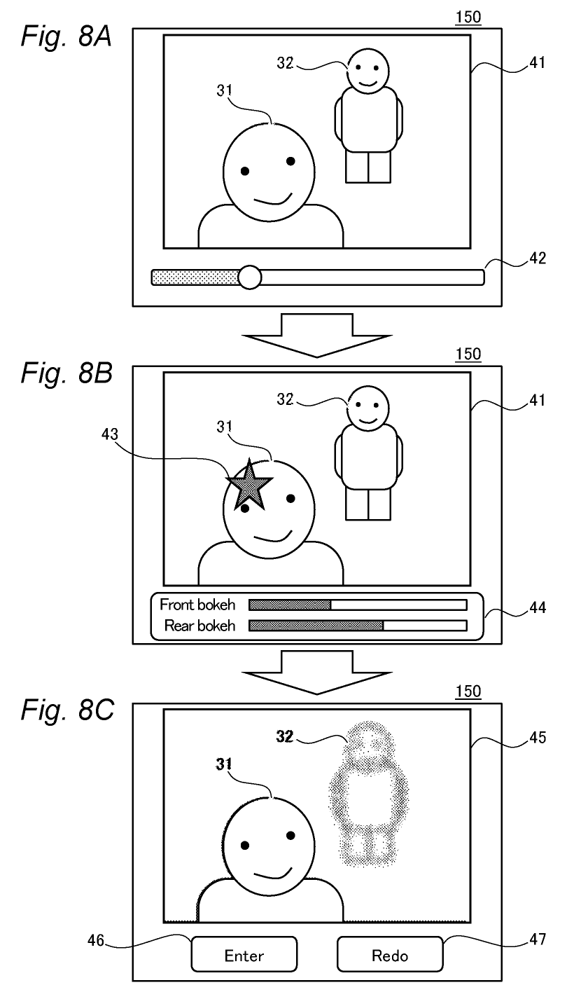

The details of the bokeh editing process in step S11 of FIG. 5 are explained using FIGS. 7 and 8.

FIG. 7 is a flowchart illustrating the bokeh editing process (S11) in the present system 10. FIGS. 8A to 8C show display examples of the bokeh editing process (S11).

First, the controller 180 displays, as playback on the display monitor 150, the video targeted for the video editing operation (FIG. 5), for example (S21). An example of the video playback screen displayed in this step S21 is shown in FIG. 8A.

The playback screen in FIG. 8A includes a playback image 41 that sequentially displays frame images of the video, and a playback bar 42 that indicates the temporal position of the frame image currently displayed as the playback image 41 within the timeline of the video. For example, the controller 180 reads the video data of the shooting result from the digital camera 100 from the memory card 250 via the card slot 190, to display the video playback screen on the display monitor 150 as shown in FIG. 8A (S21).

With displaying the video playback screen of FIG. 8A on the display monitor 150, responding to the user operation at the user interface 210, the controller 180 selects a frame image of the video and determines the frame image to be edited in the bokeh editing process (S11), for example (S22). In step S22, the user may select the first frame image as the editing target from the video displayed on the playback screen (FIG. 8A), or may select the frame image 21a at the desired time ta by operating the playback bar 42 (see FIG. 6).

Next, with displaying the frame image to be edited as the playback image 41 on the display monitor 150, the controller 180 receives the user editing operation at the user interface 210 to input the bokeh setting information (S23). For example, the user editing operation may be a touch operation on the display monitor 150 via a touch panel, or may be an operation using various physical button and the like. For example, the bokeh setting information is information setting the desired blurring method specified by the user. A display example on the display monitor 150 in step S23 is illustrated in FIG. 8B.

FIG. 8B illustrates an example of the bokeh setting screen displayed after determining the frame image to be edited (S2) in the example of FIG. 8A. The setting screen in FIG. 8B includes a playback image 41 of the frame to be edited, a bokeh reference marker 43, and a bokeh indicator 44.

The bokeh reference marker 43 indicates the bokeh reference position for the frame to be edited on the playback image 41, for example. The bokeh reference position is the position that defines the bokeh reference distance in the frame image, such as the position intended to be in focus.

In step S23, the user can place the bokeh reference marker 43 at the position (e.g., subject 31) where the user wishes to be in-focus in the playback image 41 of the desired frame, by touch operation on the bokeh setting screen, for example (FIG. 8B). Then, the controller 180 obtains the position coordinates of the bokeh reference marker 43 placed on the frame image as an example of bokeh setting information (S23).

The bokeh indicator 44 shows the degree to which an image is blurred (i.e., the bokeh level) based on depth relative to the bokeh reference marker 43. The bokeh indicator 44 may have initial values, such as the bokeh level corresponding to the predetermined depth of field of the digital camera 100. The bokeh indicator 44 accepts the user operation, such as touch operation, to change the bokeh level from the initial value.

In this example, the bokeh indicator 44 accepts the user operation to set the bokeh level for the depth in front of the bokeh reference distance corresponding to the bokeh reference marker 43, i.e., the front bokeh level, and the bokeh level for the depth behind the bokeh reference distance, i.e., the rear bokeh level. For example, the controller 180 obtains the bokeh levels (front bokeh level and rear bokeh level) set by the user operation of the bokeh level indicator 44 as an example of bokeh setting information (S23).

Next, the controller 180 performs image processing to apply a bokeh effect to the frame image being edited, based on the bokeh setting information (S23) input via the user editing operation (S24). The bokeh image processing (S24) in this embodiment focuses on the position of the bokeh reference marker 43 and applies a bokeh effect, reflecting the bokeh indicator 44, to areas at depths different from the bokeh reference marker 43 on the all-in-focus image 21. Details of the processing in step S24 will be described later.

Next, the controller 180 displays the processing result of the bokeh image processing (S24) applied to the frame image (S22) being edited, for example on the display monitor 150 (S25). An example of the display in step S25 is shown in FIG. 8C.

FIG. 8C illustrates an example of the bokeh confirmation screen displayed after FIG. 8B. The bokeh confirmation screen includes, for example as shown in FIG. 8C, the bokeh image 45 being edited as a result of the bokeh image processing (S24) applied to the target frame, an enter button 46, and a redo button 47. Displaying the bokeh image 45 being edited (S25) allows the user to view the bokeh effect based on the input bokeh setting information. For example, in the case of the frame at time ta in the example of FIG. 6, the user can verify whether the subject 32, which is not the focus target, is blurred as intended.

The controller 180 determines whether the bokeh setting information for the frame image being edited is finalized (S26) based on the user operation input to the user interface 210 with displaying such a bokeh confirmation screen (FIG. 8C) on the display monitor 150, for example.

For example, when the user wants to redo the bokeh editing for the frame image after confirming the bokeh image 45 on the bokeh confirmation screen (FIG. 8C), the user can operate the redo button 47. In response to such user operation, the controller 180 determines that the bokeh setting information is not finalized (NO in S26), to perform the processing from step S22 onwards again, for example.

On the other hand, when the user determines that the bokeh image 45 displayed on the bokeh confirmation screen (FIG. 8C) achieves the desired level of bokeh, the user can operate the enter button 46. In response to this user operation, the controller 180 determines that the bokeh setting information is finalized (YES in S26), to save the result of the bokeh editing process (S11). For example, the controller 180 stores the bokeh setting information input in step S23 and the bokeh image 45 resulting from the processing in step S24 in the buffer memory 170. The bokeh image 45 is an example of an edited image.

After storing the result of the bokeh editing process (S11), for example (S27), the controller 180 terminates the processing of step S11 in FIG. 5 and proceeds to step S12.

According to the above bokeh editing process (S11), the present system 10 can readily obtain the bokeh image 45 that aligns with the user's intent by responding to the user editing operation (S23) that sets the desired bokeh effect on the desired frame image.

For example, in this embodiment, the placement of the bokeh reference marker 43 allows the user to easily input bokeh setting information in the user editing operation (S23) where the user designates the desired subject 31 as the focus target.

In this embodiment, by setting the front bokeh and rear bokeh in the bokeh indicator 44, it is possible to respectively specify the blurring effect in front of the depth of the focused subject and the blurring effect behind it, for example. Thus, the present system 10 can provide the user with bokeh effects that would be difficult to achieve with conventional lenses, such as front bokeh and rear bokeh that differ from each other.

Alternatively, the present system 10 need not specifically differentiate between foreground and background bokeh. For example, the controller 180 may accept user input indicating a bokeh level that does not distinguish between foreground and background bokeh in the bokeh level indicator 44.

### 2.3.2. Bokeh Image Processing

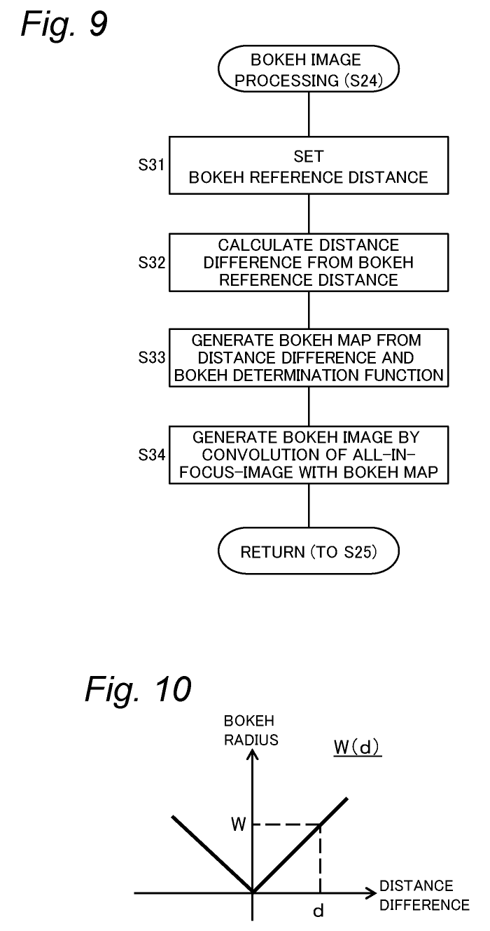

The details of the bokeh image processing in step S24 of FIG. 7 are explained using FIGS. 9 to 12.

FIG. 9 is a flowchart illustrating the bokeh image processing (S24) in the present system 10. For example, the processing shown in the flowchart of FIG. 9 begins in step S23 of the bokeh editing process (S11), with the bokeh reference position already set.

First, the controller 180 sets a bokeh reference distance for the frame image, based on a preset bokeh reference position and the depth map 22 corresponding to the frame image being edited, for example (S31). For example, in step S23 of FIG. 7, referring to the position coordinates of the bokeh reference marker 43 in the bokeh setting information input via the user editing operation as the bokeh reference position, the controller 180 sets the depth at the same position coordinates in the depth map 22 as the bokeh reference distance (S31).

Next, the controller 180 calculates the distance difference based on the set bokeh reference distance and the depth map 22 for each pixel in the all-in-focus image 21 of the frame being edited, using the bokeh reference distance as a baseline, for example (S32). For example, in step S32, the controller 180 generates a distance difference map including the distance difference as the pixel value by subtracting the bokeh reference distance from the depth of each pixel in the depth map 22. The distance differences have positive or negative signs corresponding to the relative distance compared to the bokeh reference distance.

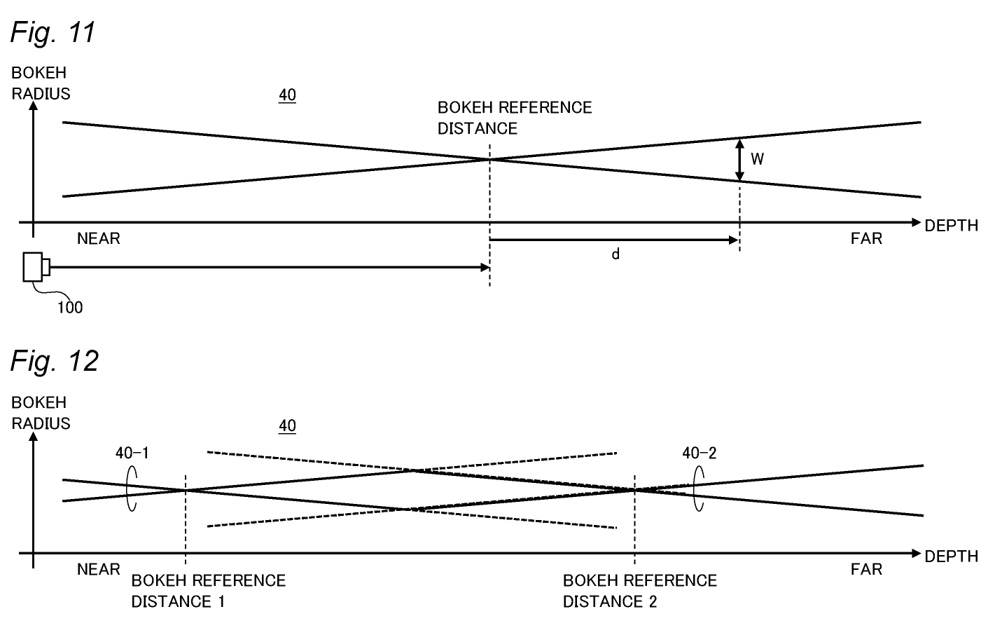

Next, the controller 180 generates a bokeh map indicating the bokeh characteristics (i.e., the bokeh amount) assigned to each pixel in the all-in-focus image 21, based on the distance difference relative to the bokeh reference distance and a preset bokeh determination function, for example (S33). The processing of step S33 is explained using FIGS. 10 to 11.

FIG. 10 is a graph showing an example of the bokeh determination function W(d) in the present system 10. FIG. 11 is a diagram for explaining the bokeh map 40 in the present system 10.

FIGS. 10 to 11 show an example using the bokeh diameter W as the bokeh amount. In the present system 10, the bokeh amount is set as the shape of the PSF, which indicates how a point image spreads due to bokeh. For example, the bokeh diameter W indicates the size of the bokeh, such as the full width at half maximum (FWHM) of the PSF. The bokeh determination function W(d), as exemplified in FIG. 10, defines the bokeh amount, such as the bokeh diameter W, according to the distance difference d relative to the bokeh reference distance.

For example, in step S33, the controller 180 first sets the slope of the bokeh determination function W(d) to be steeper based on the bokeh setting information (step S23 in FIG. 7) set by the user editing operation, such that the steeper the slope, the greater the bokeh level in the bokeh setting information. For example, the controller 180 sets the slope of the bokeh determination function W(d) to a positive value for a distance difference d corresponding to the rear bokeh level in the bokeh indicator 44, and sets the slope to a negative value for a distance difference d corresponding to the front bokeh level.

In step S33, the controller 180 generates the bokeh map 40 such that each pixel value corresponds to a bokeh diameter W for the distance difference d of that pixel, by referencing the bokeh determination function W(d) for each pixel in the distance difference map calculated in step S32. FIG. 11 illustrates an example of the relation between the bokeh diameter W, as the pixel value in this generated bokeh map 40, and the depth from the digital camera 100.

Returning to FIG. 9, the controller 180 performs a convolution operation on the frame images of the all-in-focus image 21, based on the generated bokeh map 40, thereby generating a single-frame bokeh image 45, as exemplified in FIG. 8C (S34).

For example, the convolution processing in step S34 includes an operation for calculating the pixel value of the target pixel in the bokeh image 45 for each target pixel in the all-in-focus image 21, using a kernel region, repeated for the number of pixels in the bokeh image 45. For example, the kernel region includes multiple kernel values for each pixel within a predetermined size range, and each kernel value is set by referring to the bokeh map 40.

The calculation process for the target pixel in step S34 is performed by a sum-of-products operation, for example. This operation places a kernel region centered on the target pixel within the all-in-focus image 21 and calculates the sum of the products of the kernel value at each pixel within the kernel region and the pixel value in the all-in-focus image 21. In the present system 10, referring to the bokeh diameter W of the corresponding pixel in the bokeh map 40, the controller 180 sequentially sets the kernel value corresponding to the pixel position within the kernel region in the PSF for that bokeh diameter W, for each pixel in the placed kernel region. The convolution processing in step S34 may be implemented not only by the sum-of-products operation but also by an integral operation.

The controller 180 completes the bokeh image processing (S24) by generating the bokeh image 45 (S34) and proceeds to step S25 in FIG. 7, for example.

According to the above bokeh image processing (S24), the present system 10 can generate the bokeh image 45 to have bokeh more as the distance difference d from the bokeh reference position in the in-focus image 21 is greater, using the bokeh determination function W(d) and the depth map 22, for example (S34).

In the present system 10, the flexibility of bokeh expression can be enhanced by modifying the bokeh determination function W(d) in response to the user editing operation, for example (S23 in FIG. 7). For example, when the user sets the front bokeh level and rear bokeh level to different values on the bokeh indicator 44 of FIG. 8B, the controller 180 changes the slope on the positive and negative sides of the bokeh determination function W(d) in response to the user editing operation. For instance, when the front bokeh level is set to zero, the controller 180 sets the slope in the range where the distance difference d is negative to zero in the bokeh determination function W(d). In this case, it can express a blurring effect where no front bokeh occurs.

In the present system 10, multiple bokeh reference distances may be set in the user editing operation (S23 in FIG. 7), for example. An example of operation in such a case is explained using FIG. 12.

FIG. 12 is a diagram illustrating an example of a modified bokeh map 40 in the present system 10. FIG. 12 exemplifies the case where two bokeh reference distances 1 and 2 are set in the user editing operation. For example, the controller 180 may receive user operations to place multiple bokeh reference markers 43 on the bokeh setting screen (FIG. 8B).

In this case, upon the bokeh image processing (S24), the controller 180 may generate the bokeh map 40 by synthesizing bokeh maps 40-1 and 40-2 for each bokeh reference distance 1 and 2, as exemplified FIG. 12. For example, the controller 180 generates the bokeh maps 40-1 and 40-2 for each bokeh reference distance 1 and 2, respectively, using processing similar to the above steps S32 to S33. For example, the synthesis of the bokeh map 40 can be performed by adopting the smaller pixel value bokeh diameter W for each pixel in the multiple bokeh maps 40-1 and 40-2.

In the present system 10, the controller 180 can generate a bokeh image 45 by using the bokeh map 40, generated as illustrated in FIG. 12, for convolution in the same manner as described in step S34 above. This enables the present system 10 to provide the user with bokeh effects that would be difficult to achieve with ordinary lenses, such as focusing on multiple subjects at different depths with blurring subjects at intermediate depths. In the above example, the bokeh level may be set separately for each bokeh reference distance 1 and 2, and the present system 10 may generate the bokeh map 40 using each respective bokeh determination function W(d).

In the present system 10, the convolution processing in step S34 may be performed by utilizing the depth map 22 in addition to the bokeh map 40. For example, the controller 180 may detect pixels closer than the target pixel by comparing the depth of pixels other than the target pixel within the kernel area with the depth of the target pixel, thereby changing the processing between front bokeh and rear bokeh.

For example, when the closer pixel is detected within the kernel region and the bokeh radius W of detected pixel is smaller than the bokeh radius W of the target pixel, the controller 180 may replace the bokeh radius W of the detected pixel in the bokeh map 40 within that kernel region with the bokeh radius W of another pixel within that region. This allows the present system 10 to reduce situations where a nearby subject affects the bokeh of a distant subject, thereby improving bokeh reproduction accuracy. The above replacement may be performed only when the difference between the bokeh radius W of the target pixel and the bokeh radius W of the detected pixel is greater than or equal to a predetermined threshold.

When the closer pixel is detected within the kernel region and the bokeh radius W of the detected pixel is larger than the bokeh radius W of the target pixel, the controller 180 may correct the kernel value to substantially reflect this large bokeh. Alternatively, when such a nearby subject exhibits significant bokeh, the controller 180 may correct the bokeh map 40 to expand the area of that subject. This enables the present system 10 to improve reproducibility when nearby subjects exhibit significant bokeh.

### 2.3.3. Bokeh Reflection Process

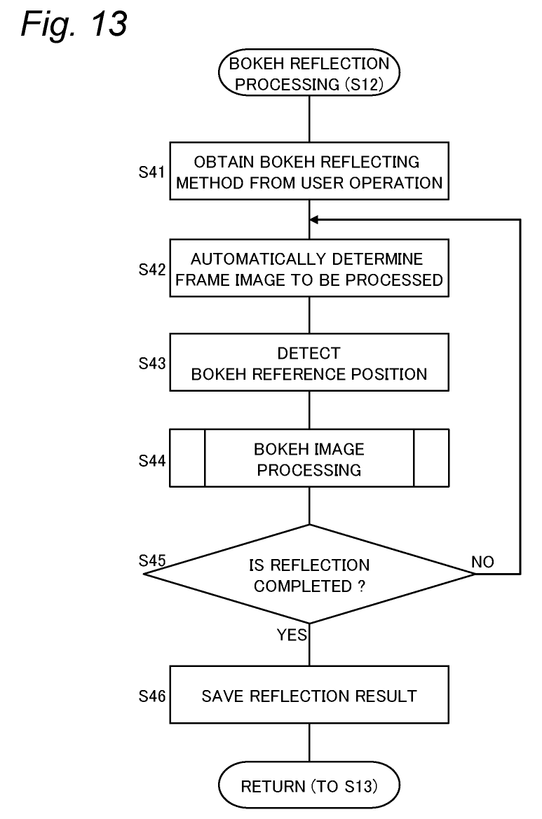

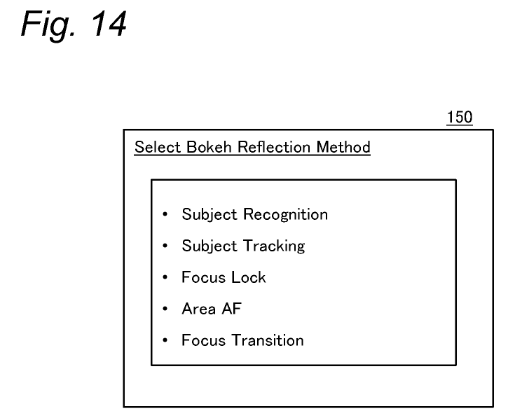

The bokeh reflection processing (S12), which reflects the editing result of one frame obtained through the bokeh editing process (S11) onto the subsequent frame images in the video in the video editing operation shown in FIG. 5, is explained using FIGS. 13 to 14.

FIG. 13 is a flowchart illustrating the bokeh reflection process (S12) in the present system 10. For example, the processing illustrated in the flow of FIG. 13 begins with the bokeh editing process (S11) saving the bokeh setting information for the editing result of one frame (S27).

First, in the present system 10, the controller 180 sets the method for reflecting the bokeh effect of the edited frame onto the video, in response to user operation at the user interface 210 (S41). A display example on the display monitor 150 in step S41 is illustrated in FIG. 14.

FIG. 14 illustrates a selection screen for bokeh reflection methods in the present system 10. This selection screen includes various bokeh reflection method options, such as "Subject Recognition," "Subject Tracking," "Focus Lock," "Area AF," and "Focus Transition." For example, the controller 180 displays the selection screen shown in FIG. 14 on the display monitor 150 to receive user operation at the user interface 210 for selecting one of the options on the selection screen (S41).

For example, "Subject Recognition" identifies the subject to be used as the bokeh reference position in the image recognition processing, such as image recognition AI, which determines the subject type. "Subject Tracking" does not specifically perform the above image recognition processing but tracks the subject area, including the bokeh reference position, using processes such as color tracking or motion tracking. "Focus Lock" fixes the bokeh reference position (or bokeh reference distance) throughout the video. "Area AF" sets the bokeh reference position within a predefined area in the image, similar to AF algorithms like single-point AF or multi-point AF.

In step S41, the controller 180 sets the time interval during which the bokeh reflection method is applied in the video, in response to user operation, for example. For instance, when "Focus Transition" is selected, the time interval from time ta to time tb in the example of FIG. 6 is set (S41). The processing in step S41 is not limited specifically to step S12 in FIG. 5 and may be performed earlier.

Next, the controller 180 automatically determines the frame image to be processed for bokeh image processing by applying the bokeh reflection method (S42). For example, in step S42, the controller 180 sequentially determines frame images for processing starting from the frame image following the one targeted for editing in the bokeh editing process (S11).

Next, the controller 180 detects the bokeh reference position in the new processing target frame image (S43), based on the bokeh reference position of the frame subject to editing via the user editing operation (S23) and the set bokeh reflection method (S41).

In step S43, for example in "Subject Recognition," the controller 180 recognizes the subject having the bokeh reference marker 43 placed by the user with image recognition processing of the new frame image to be processed, and detects the center or center of gravity position of that subject area as the new bokeh reference position. In "Subject Tracking," tracking processing is performed instead of the above image recognition processing.

The detection process in step S43 may be omitted depending on the set bokeh reflection method. For example, in "Focus Lock" mode, the bokeh reference position (or bokeh reference distance) of the bokeh reference marker 43 placed by the user editing operation (S23) can be adopted in the new frame image. In "Area AF," within a predetermined area, the position with the smallest depth and its depth can be adopted as the bokeh reference position and bokeh reference distance, for example.

In "Focus Transition," based on the temporal change of the frame from time ta as determined by the bokeh editing process (S11), the controller 180 calculates the bokeh reference distance (see FIG. 6). Alternatively, in "Focus Transition," the position on the image that is the focus target may be made to move. For example, the controller 180 may set the bokeh reference position for each frame to sequentially move in the image between the bokeh reference subject 31 at time ta and the bokeh reference subject 32 at time tb (S43).

Next, the controller 180 performs bokeh image processing on the frame image to be processed based on the detected bokeh reference position (and corresponding bokeh reference distance), for example (S44). For example, the bokeh image processing in step S44 is performed similarly to step S24, according to the bokeh setting information (S27) set in the bokeh editing process (S11). For example, in processing similar to step S31 of FIG. 9, the controller 180 sets the depth of the bokeh reference position from step S43 in the depth map 22 of the new frame to be processed as the bokeh reference distance, performs the processing of steps S32 to S34, and generates a bokeh image.

Next, the controller 180 determines whether the application of bokeh editing based on the bokeh reflection method set in the video data is complete (S44). For example, when the controller 180 finds any unprocessed frame images within the time interval where the bokeh reflection method is applied in the video data, it proceeds to NO in step S44 and repeats the processing from step S41 onwards for the unprocessed frame images.

When the bokeh editing application is complete (YES in S44), the controller 180 saves the bokeh editing result (S46). For example, the controller 180 records the video data including the bokeh image processed by the bokeh image processing (S44) for the set time interval into the buffer memory 170 or the like. The recording of the video data for saving the reflection result is not limited to step S46; it may also be performed for each of one or more frames in steps S41 to S45.

After saving the reflection result of the bokeh editing (S46), the controller 180 completes the processing of step S12 in FIG. 5 and proceeds to step S13. For example, when it subsequently proceeds to NO in step S13 and the bokeh editing process (S11) is performed again, the video including the bokeh image from the reflection result may be played back to be displayed (S21).

According to the above bokeh reflection process (S12), the present system 10 can automatically generate the video (S42 to S46) in which the bokeh effect is reflected in subsequent frame images within the video in line with the desired bokeh reflection method (S41), based on the editing result of the bokeh in the frame image intended by the user, for example.

In the bokeh reflection process (S12) of the present system 10, the processing order of the frame images may be various orders, not necessarily limited to the above. For example, the controller 180 may determine the frame images to be processed in step S42 by reversing the time order and proceeding backward.

### 3. Review

As described above, in the imaging system 10 of this embodiment, the digital camera 100, as an example of an imaging apparatus, includes an image sensor 140 as an example of an image sensor, a controller 180, and a user interface 210 as an example of an input interface. The image sensor 140 captures an image of the subject through the optical system 110 to generate image data representing the captured image 20. The controller 180 controls image processing that generates an edited image 23 based on the image data. The input interface inputs user instructions regarding the bokeh in the edited image 23 (see FIG. 8). The controller 180 generates, frame by frame, an all-in-focus image 21 that is in focus over a wider range than the captured image 20, based on the image data sequentially generated by the image sensor 140 (S4). The controller 180, in response to the user instruction input from the input interface, applies the bokeh amount to the all-in-focus image 21 in the image processing and generates video data including the edited image 23 (S11 to S14).

According to the above digital camera 100, by generating the edited video containing the edited image 23 that applies bokeh according to the user instruction to the all-in-focus image 21 shot in the video, it can facilitate to achieve bokeh in the video in line with the user's intent, for example.

In this embodiment, the digital camera 100 further includes a depth measurer 165 that obtains a depth map 22, which is an example of depth information indicating the depth at each position in the all-in-focus image 21. Based on the depth map 22, the controller 180 generates the edited image 23 by increasing the bokeh amount for each position in the all-in-focus image 21 as the depth deviates from a reference specified by the user (S24). This enables the present system 10 to achieve a natural bokeh effect in the edited image 23, where the bokeh amount increases according to depth, similar to an actual lens, making it easier to obtain bokeh in line with the user's intent.

In the digital camera 100 of this embodiment, the user instruction includes information indicating the subject to be focused on in the edited image 23 by placing a bokeh reference marker 43, for example (see FIG. 8B). This enables the present system 10 to readily obtain a bokeh image 45 in line with the user's intent through a simple user instruction indicating the subject to be focused on. The user instruction may further include a method for updating the focus target in video data (see FIG. 14). This allows the present system 10 to more easily obtain an edited video with bokeh that aligns with the user's intent.

In the digital camera 100 of this embodiment, the user instruction includes mutually different first and second focus targets such as multiple subjects 31, 32, and a time interval (t_a to t_b) in the video data during which the focus state gradually changes between the first focus target and the second focus target, for example. This enables the present system 10 to apply a bokeh reflection method, such as the focus transition in the digital camera 100, to the edited video, making it easier to obtain the edited video with bokeh in line with the user's intent.

In the digital camera 100 of this embodiment, the user instruction includes at least one of the following: the degree of blurring at a depth closer than the focus target in the edited image 23, such as the front bokeh level and rear bokeh level of the bokeh indicator 44; or the degree of blurring at a depth farther than the focus target. Such user instruction may include only either the front bokeh level or the rear bokeh level, or may include a bokeh level where the front and rear bokeh levels are identical. This enables the present system 10 to readily obtain the bokeh image 45 in line with the user's intent.

In the digital camera 100 of this embodiment, the user instruction may include multiple focus targets in the edited image 23 by positioning multiple bokeh reference markers 43, for example. The multiple focus targets may each have different depths relative to each other, as shown in FIG. 12, for example. The controller 180 may perform image processing to apply a bokeh amount at a position with a depth different from any of the multiple focus targets in the all-in-focus image 21. The present system 10 can provide the user with such flexible bokeh expression, for example.

In the digital camera 100 of this embodiment, the optical system 110 includes a phase plate 115 as an example of an optical element that encodes the captured image 20. The controller 180 restores the encoding of the captured image 20 by the phase plate 115 based on the image data to generate an all-in-focus image 21. This enables the present system 10 to readily obtain the all-in-focus image 21 using image shooting based on encoding by the phase plate 115. For example, the phase plate 115 performs encoding by imparting bokeh to the captured image 20 corresponding to a predetermined phase difference. The controller 180 can generate the all-in-focus image 21 such that it removes the predetermined blurring caused by the phase plate 115 from the captured image 20.

In this embodiment, an image processing method is provided that controls image processing to generate an edited image 23 based on image data captured of a subject image via an optical system 110. The method includes: a step (S4) where the controller 180 obtains, frame by frame, an all-in-focus image 21 that is in focus over a wider range than the captured image 20 indicated by the image data; and a step (S11 to S14) where the controller 180, in response to an input user instruction, applies a bokeh amount to the all-in-focus image 21 in the image processing to generate video data including the edited image 23.

In this embodiment, a program may be provided to cause the controller 180 to execute the above image editing method. According to this method, it becomes easier to achieve bokeh in videos that aligns with the user's intent.

In this method, obtaining the all-in-focus image 21 is not limited to generating the all-in-focus image 21 (S4). For example, in the present system 10, the image editing PC 200 or the image processing server 300 may obtain the video data of the captured video of the all-in-focus image 21 from the digital camera 100 and perform the processing of steps S11 to S14. The program for this method may be executed not only by the controller 180 of the digital camera 100, but also, for example, by the image editing PC 200 or the image processing server 300.

### Second Embodiments

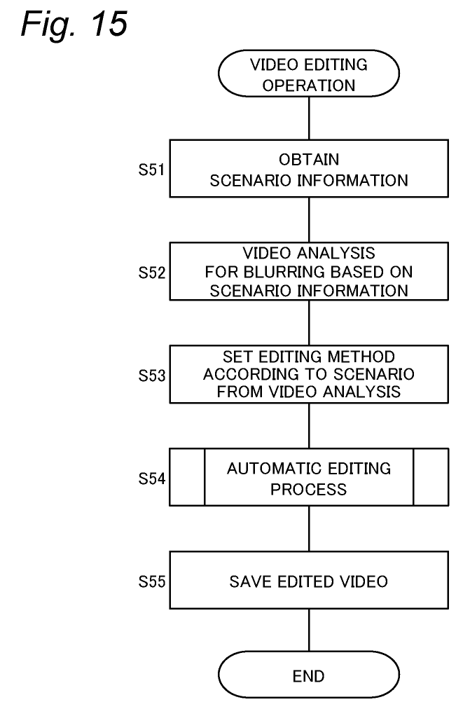

The following describes a second embodiment of the present disclosure using FIGS. 15 to 17. The first embodiment has been described the imaging system 10 that reflects the bokeh amount in the video based on the user editing operations. The second embodiment describes an imaging system 10 that applies the bokeh amount to a video according to a scenario.

The following description of the imaging system 10 and digital camera 100 according to this embodiment will omit explanations of configurations and operations identical to those of the imaging system 10 and digital camera 100 according to the first embodiment, as appropriate.

FIG. 15 is a flowchart illustrating the video editing operation in the imaging system 10 of the second embodiment. In the imaging system 10 of this embodiment, after performing a video shooting operation (FIG. 4) similar to that of the first embodiment, for example, instead of the video editing operation shown in FIG. 5, a scenario-based video editing operation is performed on the obtained video data, as shown in FIG. 15, for example. For example, the scenario includes the composition, content, or progression of the video the user wishes to capture.

For example, the scenario in this embodiment may be one where the bokeh reference position or the subject to be blurred is unknown beforehand. For instance, in a video shooting of a scene such as a footrace, the scenario may be "focus on the winner among multiple runners and blur the other runners." The user may input the scenario information into the digital camera 100 using the microphone 270 by speaking the scenario, for example.

In the video editing operation of this embodiment (FIG. 15), the controller 180 first obtains the scenario information (S51), based on audio input from the microphone 270, for example. The present system 10 can perform speech recognition processing on such audio input to generate scenario information in text format, for example.

Alternatively, in step S51, the controller 180 may obtain the scenario information in response to user operation at the user interface 210, or may read pre-stored scenario information from the memory card 250 via the card slot 190. The controller 180 may obtain the scenario information via data communication with an external device through the communication module 260 (S51).

Next, based on the obtained scenario information (S51), the controller 180 analyzes the subject to be recognized from the video to determine the blurring method, such as the bokeh reference and bokeh level, and performs image recognition of the subject to be recognized in the video based on the analysis results of the scenario information (S52). In the present system 10, the scenario information may constitute a prompt for generative AI or the like, and the present system 10 may use an AI agent to identify information regarding the bokeh reference and bokeh level.

For example, in step S52, analysis of the aforementioned footrace scenario information identifies the subject for the bokeh reference as the "winner," who can be recognized as the subject arriving first in the finish scene in the video. Based on this analysis result, the controller 180 performs scene identification and individual identification image recognition on the shot video, identifying the subject of the first-arriving winner in the finish scene as the bokeh reference for the focus target (S52). Furthermore, based on the analysis results for determining the bokeh level from the scenario information, the controller 180 calculates the bokeh level required to blur runners other than the winner, by image recognition on the frame image where the winner is closest to the other runners in the recorded race video, for example (S52).

Next, based on the image recognition result of the blurring method obtained by analyzing the scenario information (S52), the controller 180 automatically sets the editing method for blurring according to the scenario (S53). For example, in the aforementioned footrace scenario, the controller 180 sets the initial position of the winner in the video as the initial bokeh reference position and then sets a bokeh reflection method such as "subject recognition" or "subject tracking" in subsequent frames, similar to the first embodiment.

Next, the controller 180 performs processing to generate an edited video reflecting the automatically set bokeh editing method (S53), for example (S54). For example, the automatic editing processing (S54) of this embodiment can be performed, based on the bokeh editing method set in step S53, using processing similar to steps S42 to S46 (FIG. 13) of the bokeh reflection process (S12) of the first embodiment. Thus, the controller 180 generates the edited video with the bokeh automatically edited (S54) and saves the edited video (S55), for example, in the same manner as in the first embodiment (S14 in FIG. 5).

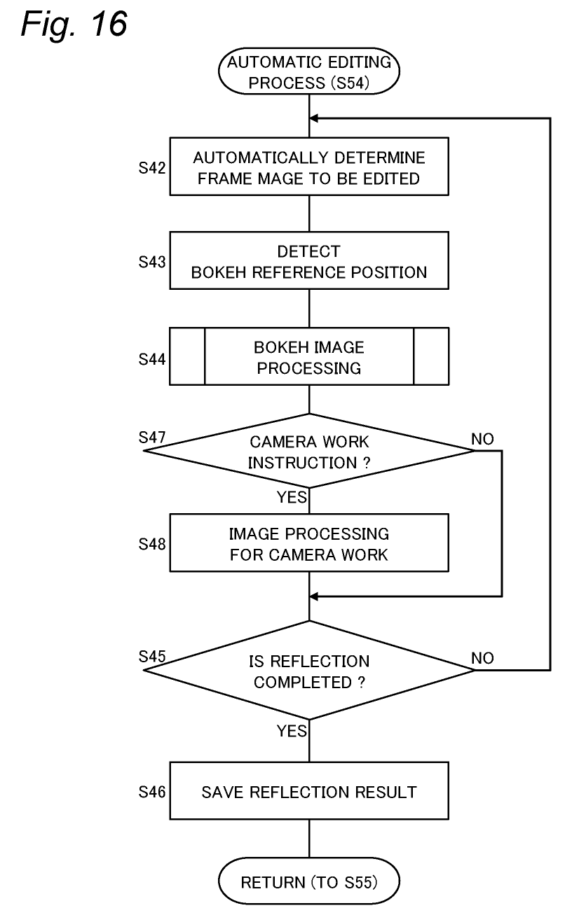

In the automatic editing process (S54) of this embodiment, in addition to automatic editing of bokeh, video editing that reproduces camera work such as zooming-in may also be automated. An example of such operation is explained using FIG. 16.

FIG. 16 is a flowchart illustrating the automatic editing process (S54) in this embodiment. In the automatic editing process (S54) of this embodiment, the controller 180 performs processing reflecting a camera work instruction (S47, S48), as exemplified in FIG. 16, in addition to processing similar to steps S42 to S46 in FIG. 13. The camera work instruction is included in advance in the scenario information, for example.

For example, the controller 180 determines whether the scenario information includes the camera work instruction (S47). When camera work instruction is present (YES in S47), the controller 180 performs image processing corresponding to the camera work specified in the instruction (S48). On the other hand, when no camera work instruction is present (NO in S47), the controller 180 does not perform the processing of step S48 in particular and proceeds to step S45, for example.

For example, the scenario information in this embodiment may further include instruction such as zooming-in on specific subjects, like the winner's face, as the footrace progresses in the aforementioned footrace scenario. In this case, the controller 180 proceeds to YES in step S47 and performs zoom-in image processing to extract an image area containing the specific subject from the frame image (S48). Furthermore, in each step S48 as the video progresses, the controller 180 sequentially narrows the image area extracted from the frame image to increase the zoom magnification.

According to the above processing, the present system 10 can perform image processing for camera work such as zooming-in according to the scenario, together with bokeh editing (S47, S48). The camera work instruction is not limited to zooming in specifically; it may also be panning or zooming-out. In such cases, for example, the image area to be adopted into the edited video may be restricted from the entire field of view of the frame image starting from the initial point of the video.

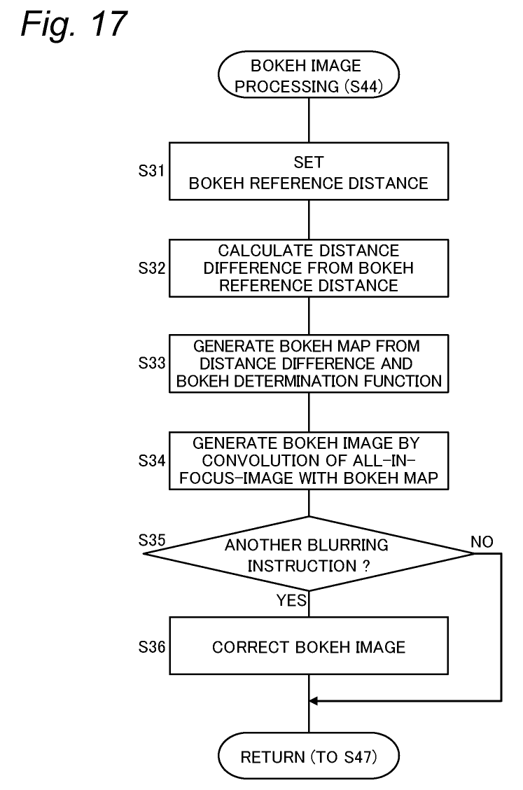

Furthermore, the imaging system 10 of this embodiment may respond to user instruction to bokeh or not bokeh specific subjects independently of the bokeh reference described above, for example within scenario information. An example of such operation is explained using FIG. 17.

FIG. 17 is a flowchart illustrating the bokeh image processing (S44) in this embodiment. In the bokeh image processing (S44) of this embodiment, the controller 180 performs processing similar to steps S31 to S34 of the first embodiment (FIG. 9), for example. Furthermore, as illustrated in FIG. 17, it performs processing reflecting blurring instruction separate from the bokeh criteria (S35, S36).

For example, such blurring instruction may, from a privacy perspective, specify blurring a particular subject regardless of distance from the bokeh threshold, or may specify blurring the faces of other individuals while leaving the face of a specific person or persons unblurred.

For example, the controller 180 determines whether the scenario information includes such a blurring instruction (S35). When a blurring instruction is present (YES in S35), the controller 180 performs image processing to correct the bokeh image, which is generated in step S34 based on the bokeh reference similarly to the first embodiment, according to the blurring instruction (S36). On the other hand, when no blurring instruction is present (NO in S35), the controller 180 does not perform the processing of step S36 in particular and proceeds to step S47, for example.

According to the above processing, the present system 10 can apply a wider variety of user-desired bokeh effects, such as privacy bokeh, making video production easier.

In the present system 10, reflecting such blurring instruction is not limited to correcting the bokeh image generated in step S34 (S36), but may also be performed by correcting the bokeh map 40, for example (S33). In this case, the controller 180 can more easily obtain the desired bokeh image through simple processing, such as limiting the bokeh radius of the subject to be blurred to a value greater than or equal to a predetermined value, or limiting the bokeh radius of the subject not to be blurred to a value less than or equal to a predetermined value.

As described above, in the digital camera 100 of the present system 10, the user instruction includes scenario information indicating a scenario planned for the video indicated by the video data (S51). The controller 180 generates video data containing the edited image 23 by applying blurring to each frame of the video during image processing according to the scenario information (S53 to S55). This enables the present system 10 to readily achieve blurring in the video that aligns with the user's intent through automatic editing of blurring based on the scenario information.

In the digital camera 100 of this embodiment, the user instruction may include camera work instruction within the scenario information (S47). This enables the present system 10 to automate video editing (S48) that incorporates camera movement, making it easier to perform video editing in line with the user's intent.

In the digital camera 100 of this embodiment, the user instruction may include an instruction for blurring a specific subject within the scenario information (S35). This enables the present system 10 to control the blurring method for specific subjects according to the user instruction (S36), in addition to producing natural bokeh effects based on bokeh criteria, thereby facilitating editing of bokeh effects in line with the user's intent.

### Other Embodiments

As described above, the first and second embodiments have been explained as examples of the technology disclosed in this application. However, the technology disclosed herein is not limited to these embodiments and may also be applied to other embodiments that appropriately modify, replace, add, or omit elements. Furthermore, it is possible to combine the various components described in the above embodiments to create new embodiments.

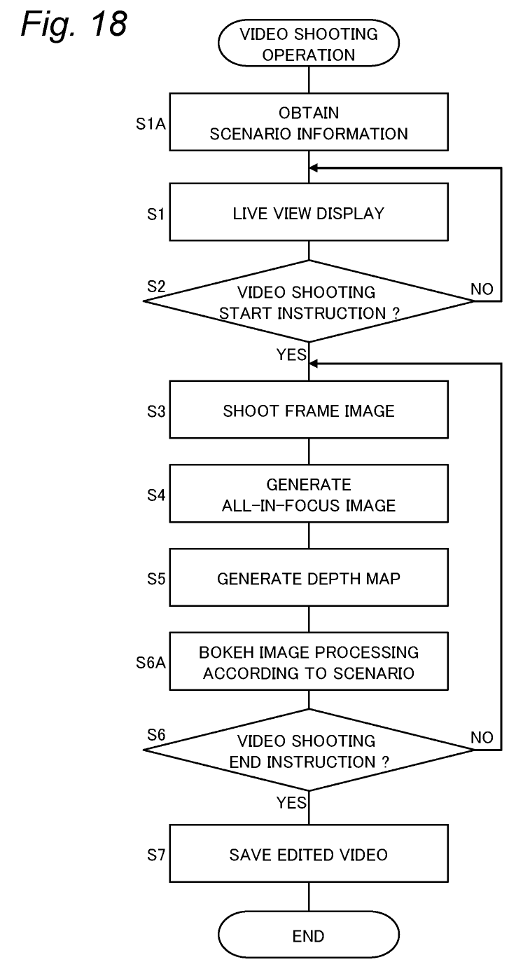

In the above first and second embodiments, the imaging system 10 has been described as performing the video editing operation after video shooting. In this embodiment, the video editing operation may be performed during video shooting. This modification will be explained using FIG. 18.

FIG. 18 illustrates the operation of a modified example of the present system 10. In this embodiment, the controller 180 of the digital camera 100 performs steps S1 to S7, similar to the video shooting operation (FIG. 4) of the first embodiment, for example. In this embodiment, the controller 180 obtains the scenario information (S1A), similar to step S51 of the second embodiment, for example. The scenario information in this embodiment may be content that can identify video editing methods, such as bokeh, during video shooting, for example.

In this embodiment, the controller 180 performs bokeh image processing frame by frame (S6A), based on the obtained scenario information, for example during the video shooting execution (S3 to S6). The controller 180 can perform the bokeh image processing (S6A) of this embodiment in the same manner as in the second embodiment, for example. As a result of this video shooting processing (S3 to S6), the controller 180 can save an edited video including the bokeh image from the bokeh image processing (S6A), alternatively or additionally to the recorded video (S7).

As described above, in the present system 10, the digital camera 100 can perform bokeh image processing (S6A) based on scenario information during video shooting to generate the edited video including the bokeh image. This simplifies the video production workflow for the present system 10.

In the above embodiments, a phase plate 115 for wavefront encoding has been described as the example of the optical element for encoding in the optical system 110. In this embodiment, the optical element encoding the captured image 20 in the optical system 110 need not be the phase plate 115; it may instead be an aperture diaphragm having an aperture shape for encoding, for example. Using such an optical element, the present system 10 can still generate the all-in-focus image 21 by restoring it from the encoded captured image 20.

The above embodiments have described the imaging system 10 that generates the all-in-focus image 21 by restoring the captured image 20 encoded by the optical element in the optical system 110. However, the present disclosure is not limited thereto. For example, the imaging system 10 of this embodiment may generate the all-in-focus image 21 using a light field. Alternatively, the imaging system 10 may generate the all-in-focus image by synthesizing multiple frames of captured images. Furthermore, the imaging system 10 need not necessarily generate the all-in-focus image specifically through image processing; it may shoot the all-in-focus image using pan-focus shooting, for example. To obtain such an all-in-focus image by the image shooting, the imaging system 10 may use a narrowed aperture or employ an optical system or image sensor with a deep depth of field.

Furthermore, the present system 10 does not necessarily require the use of all-in-focus images. For example, the present system 10 may apply a bokeh amount to the captured image or perform image processing to post-focus on blurred subjects in the captured image. For example, the controller 180 may perform image processing that simulates the depth effect of the captured field to bring the blurred subject into focus, based on the depth map 22 corresponding to the captured image 20. This simulation may involve sharpening the appearance of the subject by edge enhancement.

The above embodiments have described the imaging system 10 that generates the video including the edited bokeh image. In this embodiment, the imaging system 10 is not necessarily limited to the video; it may also be applied to a still image, generating the edited bokeh image as the still image in the same manner as described in the above embodiments. This enables the present system 10 to facilitate the user's attainment of intended bokeh effects in still images.

In the above embodiments, the digital camera 100 constituting the imaging system 10 has been described. In this embodiment, the digital camera 100 need not specifically constitute the imaging system 10.

In the above embodiments, the display monitor 150 has been illustrated as the example of the display. In the digital camera 100 of this embodiment, the display is not limited to the display monitor 150; it may also be an EVF (electronic viewfinder) or an output module that outputs video signals according to standards such as HDMI, for example.

In the above embodiments, the digital camera 100 equipped with the optical system 110 and a lens driver 120 has been illustrated. The imaging apparatus of this embodiment need not necessarily include the optical system 110 and the lens driver 120; it may be an interchangeable lens camera, for example.

In the above embodiments, a digital camera has been described as the example of the imaging apparatus, but this is not limited thereto. The imaging apparatus of the present disclosure may be any electronic device with image shooting function (e.g., a video camera, smartphone, tablet device, or so on).

As described above, embodiments have been explained as examples of the technology disclosed herein. For this purpose, the accompanying drawings and detailed description have been provided.

Therefore, the components described in the attached drawings and detailed description may include not only those essential for solving the problem, but also components that are not essential for solving the problem, merely to illustrate the above technology. Consequently, the mere fact that these non-essential components are described in the attached drawings or detailed description should not immediately lead to the determination that these non-essential components are essential.

Furthermore, the above embodiments are intended to illustrate the technology disclosed herein; therefore, various modifications, substitutions, additions, and omissions may be made within the scope of the claims or their equivalents.

### Exemplary Aspects

The following are exemplary aspects of the present disclosure.

A first aspect of the present disclosure relates to an imaging apparatus including: an image sensor configured to capture an image of a subject via an optical system to generate image data indicating a captured image; a controller configured to control image processing to generate an edited image based on the image data; and an input interface configured to input user instruction on bokeh in the edited image. The controller is configured to: generate an all-in-focus image for each frame based on the image data sequentially generated by the image sensor, the all-in-focus image being in focus over a wider range than the captured image; and generate video data including the edited image with the image processing applying a bokeh amount to the all-in-focus image in accordance with the user instruction input via the input interface.

A second aspect is the imaging apparatus according to the first aspect, further including a depth measurer configured to obtain depth information indicating depth at each position in the all-in-focus image. The controller is configured to generate the edited image by increasing, based on the depth information, the bokeh amount for each position in the all-in-focus image as the depth deviates from a reference defined by the user instruction.

A third aspect is the imaging apparatus according to the first or second aspect, wherein the user instruction includes information indicating a focus target to be in-focus in the edited image.

A fourth aspect is the imaging apparatus according to any one of the first to third aspects, wherein the user instruction includes: first and second focus targets different from each other; and a time interval in which a focus state gradually changes between the first focus target and the second focus target for the video data.

A fifth aspect is the imaging apparatus according to any one of the first to fourth aspects, wherein the user instruction includes at least one of: a degree to which the image is blurred at the depth closer than the focus target in the edited image; or a degree to which the image is blurred at the depth farther than the focus target.

A sixth aspect is the imaging apparatus according to any one of the first to fifth aspects, wherein the user instruction includes multiple focus targets for the edited image. The multiple focal targets have respectively depths different from each other.

A seventh aspect is the imaging apparatus according to any one of the first to sixth aspects, wherein the user instruction includes scenario information indicating a scenario planned for a video indicated by the video data. The controller is configured to generate the video data including the edited image with the image processing applying the bokeh amount to each frame of the video, according to the scenario information.

An eighth aspect is the imaging apparatus according to the seventh aspect, wherein the user instruction includes an instruction on camera work in the scenario information.

A ninth aspect is the imaging apparatus according to the seventh or eighth aspect, wherein the user instruction includes an instruction for blurring a specific subject in the scenario information.

A tenth aspect is the imaging apparatus according to any one of the first to ninth aspects, wherein the optical system includes an optical element configured to encode the captured image. The controller is configured to decode, based on the image data, the captured image encoded by the optical element, to generate the all-in-focus image.

An eleventh aspect is an image processing method for controlling image processing to generate an edited image based on image data obtained by capturing an image of a subject via an optical system. The image processing method includes: obtaining, by a controller, an all-in-focus image frame by frame, the all-in-focus image being in focus over a wider range than a captured image indicated by the image data; and generating, by the controller, video data including the edited image with the image processing applying a bokeh amount to the all-in-focus image in accordance with an input user instruction.

A twelfth aspect is a program or a non-transitory computer-readable recording medium storing the program for causing the controller to execute the image processing method according to the eleventh aspect.

A thirteenth aspect is an imaging apparatus including: an image sensor configured to capture an image of a subject via an optical system to generate image data indicating a captured image; a controller configured to control image processing to generate an edited image based on the image data; and an input interface configured to input user instruction on bokeh in the edited image. The user instruction includes scenario information indicating a scenario planned for a video. The controller is configured to generate video data including the edited image with the image processing applying a bokeh amount to each frame of the video, according to the scenario information.

The present disclosure is applicable to various image processing techniques for editing bokeh in image.

1. An imaging apparatus comprising:
an image sensor configured to capture an image of a subject via an optical system to generate image data indicating a captured image;
a controller configured to control image processing to generate an edited image based on the image data; and
an input interface configured to input user instruction on bokeh in the edited image;
wherein the controller is configured to:
generate an all-in-focus image for each frame based on the image data sequentially generated by the image sensor, the all-in-focus image being in focus over a wider range than the captured image; and
generate video data including the edited image with the image processing applying a bokeh amount to the all-in-focus image in accordance with the user instruction input via the input interface.

2. The imaging apparatus according to claim 1, further comprising a depth measurer configured to obtain depth information indicating depth at each position in the all-in-focus image,
wherein the controller is configured to generate the edited image by increasing, based on the depth information, the bokeh amount for each position in the all-in-focus image as the depth deviates from a reference defined by the user instruction.

3. The imaging apparatus according to claim 1, wherein the user instruction includes information indicating a focus target to be in-focus in the edited image.

4. The imaging apparatus according to claim 1, wherein the user instruction includes: first and second focus targets different from each other; and a time interval in which a focus state gradually changes between the first focus target and the second focus target for the video data.

5. The imaging apparatus according to claim 1, wherein the user instruction includes at least one of: a degree to which the image is blurred at the depth closer than the focus target in the edited image; or a degree to which the image is blurred at the depth farther than the focus target.

6. The imaging apparatus according to claim 1,
wherein the user instruction includes multiple focus targets for the edited image, and
the multiple focal targets have respectively depths different from each other.

7. The imaging apparatus according to claim 1,
wherein the user instruction includes scenario information indicating a scenario planned for a video indicated by the video data, and
the controller is configured to generate the video data including the edited image with the image processing applying the bokeh amount to each frame of the video, according to the scenario information.

8. The imaging apparatus according to claim 7, wherein the user instruction includes an instruction on camera work in the scenario information.

9. The imaging apparatus according to claim 7,
wherein the user instruction includes an instruction for blurring a specific subject in the scenario information.

10. The imaging apparatus according to claim 1,
wherein the optical system includes an optical element configured to encode the captured image, and
the controller is configured to decode, based on the image data, the captured image encoded by the optical element, to generate the all-in-focus image.

11. An image processing method for controlling image processing to generate an edited image based on image data obtained by capturing an image of a subject via an optical system, the image processing method comprising:
obtaining, by a controller, an all-in-focus image frame by frame, the all-in-focus image being in focus over a wider range than a captured image indicated by the image data; and
generating, by the controller, video data including the edited image with the image processing applying a bokeh amount to the all-in-focus image in accordance with an input user instruction.

12. A non-transitory computer-readable recording medium storing a program for causing the controller to execute the image processing method according to claim 11.

13. An imaging apparatus comprising:
an image sensor configured to capture an image of a subject via an optical system to generate image data indicating a captured image;
a controller configured to control image processing to generate an edited image based on the image data; and
an input interface configured to input user instruction on bokeh in the edited image;
wherein the user instruction includes scenario information indicating a scenario planned for a video, and
the controller is configured to generate video data including the edited image with the image processing applying a bokeh amount to each frame of the video, according to the scenario information.
